(19) United States
(12) Patent Application Publication
(10) Pub. No.: US 2002/0185953 A1
(43) Pub. Date: Dec. 12, 2002

(54) Electron gun for a color braun-tube

(76) Inventor: Jin Yeal Choi, Kyongsangbuk-do (KR)

Correspondence Address: FLESHNER & KIM, LLP, P.O. Box 221200, Chantilly, VA, 20153-1200, US

(21) Appl. No.: 09/878,321

(22) Filed: Jun. 12, 2001

(51) Int. Cl. H01J 29/50

(52) U.S. Cl. 313/409

(57) ABSTRACT

Electron gun in a color CRT including a plurality of stem pins for applying different voltages, an acceleration electrode, a third electrode, a fourth electrode, and a static electrode, for forming pre-focus lenses, a dynamic electrode and an anode for forming a main focus lens, the static electrode and the dynamic electrode for forming a quardrupole lens, bead glass for holding the foregoing electrodes at fixed distances, a first wire having one end welded to the dynamic electrode, the other end welded to the stem pin a dynamic voltage applied thereto, and a body between the one end and the other end having an evasive form so as not to come into contact with neighboring members, and a second wire having one end welded to the third electrode, the other end welded to the stem pin a static voltage applied thereto, and a body between the one end and the other end having an evasive form so as not to come into contact with neighboring members, thereby minimizing noise, spark, and neck damage.

### BACKGROUND OF THE INVENTION

1. Field of the Invention

The present invention relates to a color cathode ray tube, and more particularly, to an electron gun in a color CRT.

2. Background of the Related Art

Referring to FIG. 1, in general, the color CRT is provided with a panel 1 having a R, G, or B fluorescent film coated on an inside surface thereof, a funnel 2 welded to a rear end of the panel for sustaining vacuum of an inside space of the CRT, an electron gun 5 sealed in the neck part 3 of the funnel for emitting electron beams 4, a deflection yoke 6 for deflecting the electron beams emitted from the electron gun, and a shadow mask 7 for selecting a color of the electron beams deflected by the deflection yoke.

In the meantime, the electrodes in the electron gun of the color CRT are positioned at fixed intervals vertical to an electron path so that the electron beams 4 from the cathodes (see 18 in FIG. 1) are controlled to a certain strength before the electron beams 4 reach to a screen 8.

Referring to FIGS. 1 and 2, the electron gun 5 has three independent cathodes 18, a first electrode 11 spaced a distance away from the cathodes, a common grid of the three cathode, a second electrode 12, a third electrode 13, a fourth electrode 14, a fifth electrode 15, a sixth electrode arranged in succession at fixed intervals from the first electrode, and a shield cup 17 forward of the sixth electrode 16 having a B.S.C (Bulb Space Connector) (not shown) fitted thereto for shielding an external electric and magnetic field. Also there is bead glass 19 on both sides of the electrodes for glass welding the electrodes at fixed intervals, and a shield tab 20 having both sides welded to the 5-1 electrode 15a and a center part welded to a surface of the bead glass in a band form, for prevention of a stray emission. There are a first pre-focus lens formed between the second electrode 12 and the third electrode 13, acceleration electrodes, for enhancing an electron beam focusing power by focusing the electron beam 4 in advance, a second pre-focus lens formed between the third electrode 13 and a fourth electrode 14, and a third pre-focus lens formed between the fourth electrode 14 and the fifth electrode 15. There is a main-focus lens formed between the fifth electrode 15 and the sixth electrode 16 for main focusing the electron beams 4. In order to halo when the electron beams 4 are deflected to a periphery of the screen, the fifth electrode 15 is divided as follows. The fifth electrode 15 is divided into a 5-2 electrode 15b having a dynamic electrode applied thereto, and a 5-1 electrode 15a, a static grid, having a static voltage applied thereto, to form a quardrupole lens between the 5-1 electrode and the 5-2 electrode. The third electrode 13 has a dynamic voltage the same with the 5-2 electrode applied thereto as a ‘┌’ formed wire 22 is included that connects the third electrode 13 and the stem pin 21 by welding and placed on the bead glass 19.

The foregoing electron gun is operative as follows. The electron beams 4, controlled and accelerated as the electron beams 4 pass through the first electrode 11 and the acceleration electrode 12, is subjected to a first focusing as the electron beams pass through the pre-focus lens formed by a potential difference, and focused and accelerated as the electron beams 4 pass the main focus lens formed by a potential difference, to form an electron spot on the screen 8. The formation of halo of the electron beam spot when the electron beams 4 are deflected to a periphery of the screen can be prevented by means of the quardrupole lens formed by the dynamic voltage and the static voltage.

Referring to FIG. 4, voltages applied to respective electrodes will be explained. In general, the anode has around 20,000V-32,000V applied thereto, the third electrode 13 and the dynamic electrode 15b have the same voltages of 6,000V-10,000V applied thereto respectively, and the deflection yoke 6 has a voltage applied thereto varied with a deflection position of the electron beams. The static grid 15a, the acceleration electrode 12, and the fourth electrode 14 have the same voltages of 300V-1,000V applied thereto respectively, and, particularly, the static grid has a static voltage that is constant and does not vary with the deflection current applied thereto.

Since there are very high voltages applied to respective electrodes, there is a dark current flowing through the neck part 3. Therefore, in order to prevent the dark current flowing through the bead glass 19, the stray emission prevention shield tab 20 is welded to a surface of the bead glass 19. That is, both ends of the shield tab 20 are welded to the static grid 15a, and a center part of the shield tab 20 is welded to the bead glass 19 in a band form.

In the meantime, a related art disclosed in U.S. Pat. No. 4,485,327 will be explained, which enhances a service of the shield tab 20 by using the wire 22.

Referring to FIGS. 2 and 3, the ‘┌’ formed wire 22 connects the third electrode 13 and the stem pin 21 by welding, and placed on the bead glass 19 for preventing flow of the dark current. However, the related art has the following problems. As shown in FIG. 3, since the wire provided for prevention of a dark current flow is bent toward the bead glass 19, the wire 22 comes closer to an inside wall of the neck part 3, to cause breakage of the neck part 3 when the wire 22 is caught at an inside surface of the neck part 3, and a sudden spark as a potential difference at the inside wall of the neck part 3 becomes greater. As the dynamic voltage applied to the stem pin 21 is a voltage varied with time, the wire 22 and the bead glass 19 are liable to vibration when the electron beams 4 move, to cause contact noise between the wire 22 and the bead glass 19.

### SUMMARY OF THE INVENTION

Accordingly, the present invention is directed to an electron gun in a color CRT that substantially obviates one or more of the problems due to limitations and disadvantages of the related art.

An object of the present invention is to provide an electron gun in a color CRT, which can minimize noise, spark, and neck breakage.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the electron gun in a color cathode ray tube (CRT) includes a wire having one end welded to the third electrode, the other end welded to the stem pin a dynamic voltage applied thereto, and a body between the one end and the other end having an evasive form so as not to come into contact with neighboring members.

In another aspect of the present invention, there is provided an electron gun in a color CRT including a first wire having one end welded to the dynamic electrode, the other end welded to the stem pin a dynamic voltage applied thereto, and a body between the one end and the other end having an evasive form so as not to come into contact with neighboring members, and a second wire having one end welded to the third electrode, the other end welded to the stem pin a static voltage applied thereto, and a body between the one end and the other end having an evasive form so as not to come into contact with neighboring members.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a longitudinal section of a related art CRT;

FIG. 2 illustrates a related art electron gun;

FIG. 3 illustrates a cross section showing a position of a wire in a related art electron gun;

FIG. 4 illustrates voltage applications to respective electrodes in a related art electron gun;

FIG. 5 illustrates a system in accordance with a first preferred embodiment of the present invention;

FIG. 6 illustrates a system in accordance with a second preferred embodiment of the present invention;

FIG. 7 illustrates a cross section of an electron gun in accordance with a second preferred embodiment of the present invention, for showing a position of a wire fitting; and,

FIG. 8 illustrates a cross section of an electron gun in accordance with a second preferred embodiment of the present invention, for showing voltage applications to respective electrodes.

### DETAILED DESCRIPTION OF THE PREFERRED EMBODIMENT

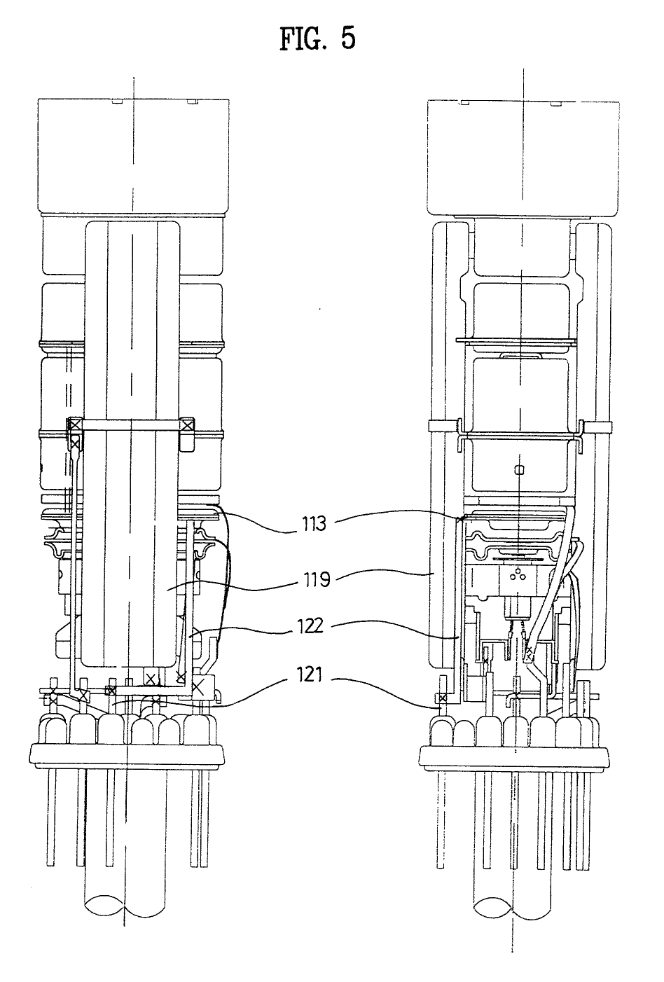

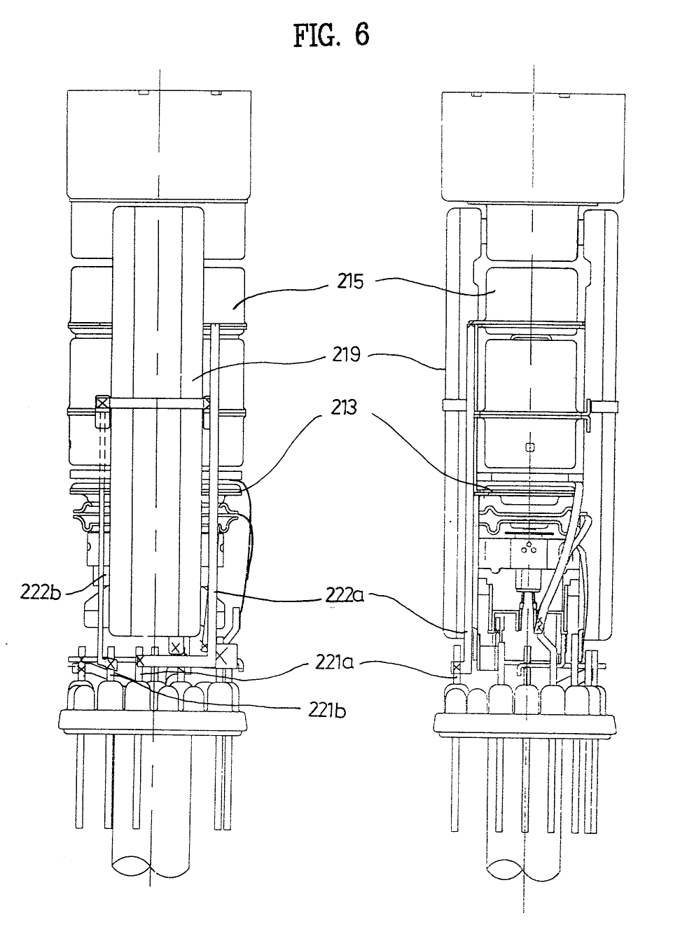

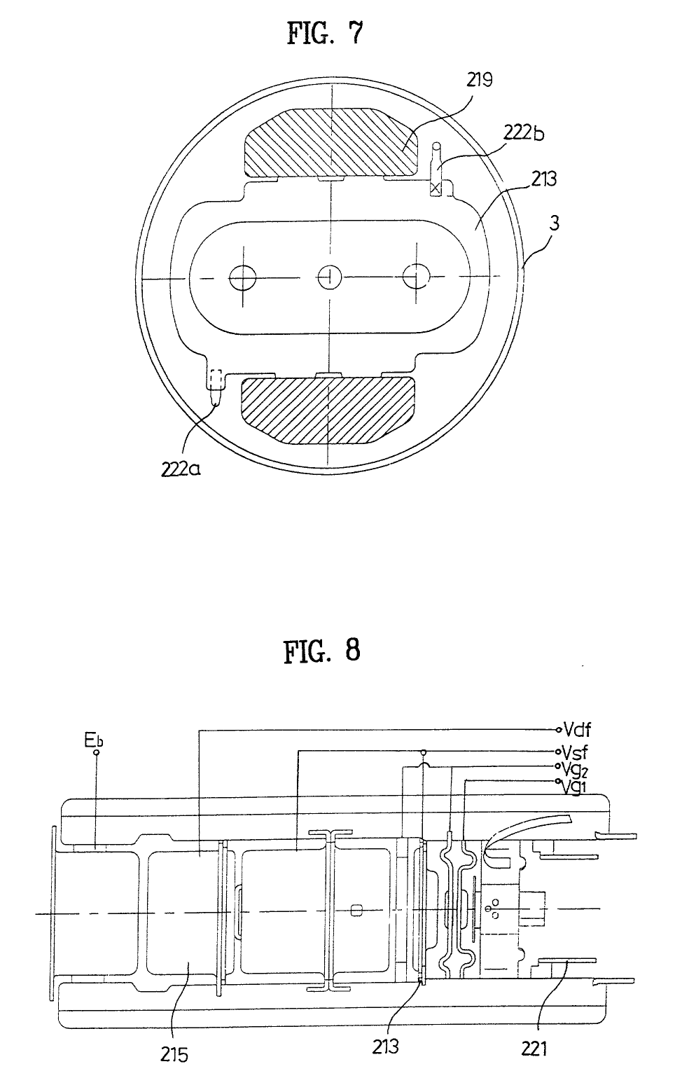

Reference will now be made in detail to the preferred embodiments of the present invention, examples of which are illustrated in the accompanying drawings. FIG. 5 illustrates a system in accordance with a first preferred embodiment of the present invention, FIG. 6 illustrates a system in accordance with a second preferred embodiment of the present invention, FIG. 7 illustrates a cross section of an electron gun in accordance with a second preferred embodiment of the present invention, for showing a position of a wire fitting, and FIG. 8 illustrates a cross section of an electron gun in accordance with a second preferred embodiment of the present invention, for showing voltage applications to respective electrodes.

Referring to FIGS. 5 and 7, the first preferred embodiment of the present invention has the following elements. In the foregoing color CRT, a wire 122 is included thereto, which has one end welded to the third electrode 113, the other end welded to the stem pin 121 having a dynamic voltage applied thereto, and a body between the one end and the other end having an evasive form so as not to come into contact with neighboring members.

The operation and work of the first preferred embodiment of the present invention will be explained.

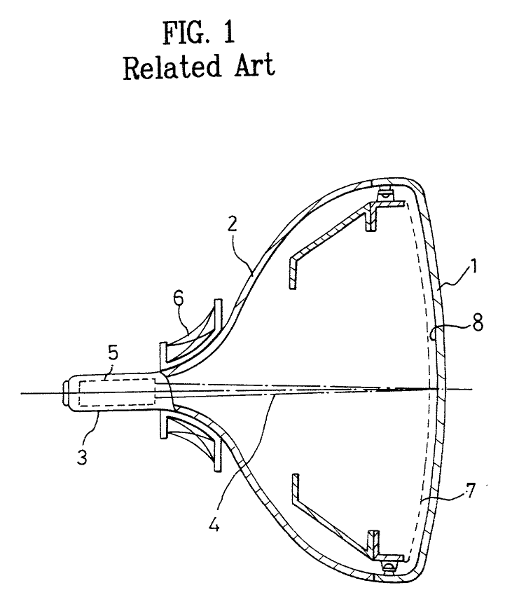

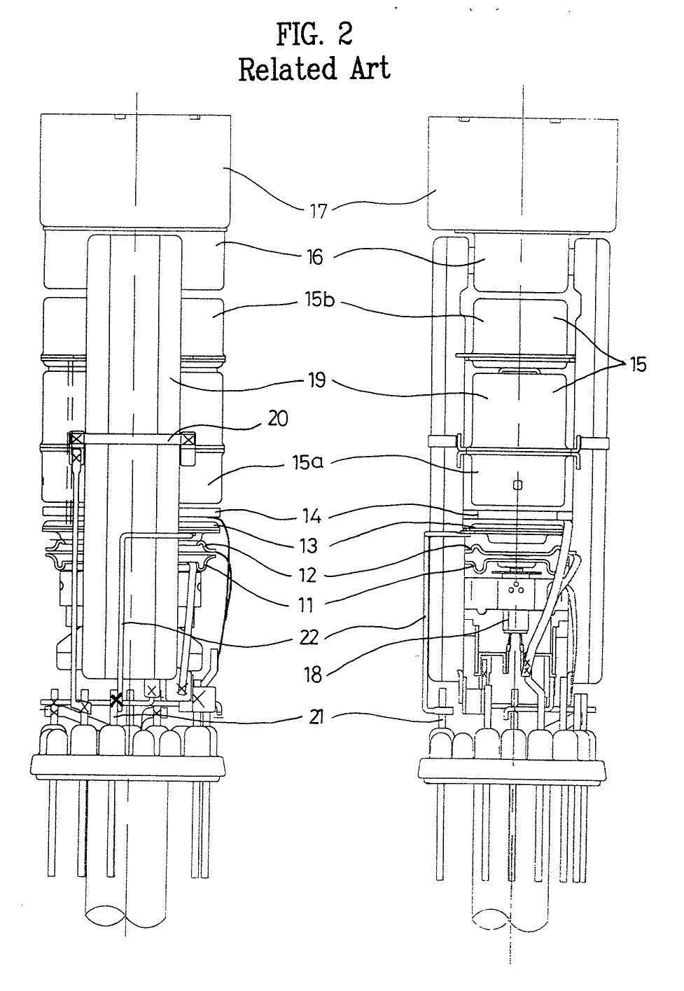

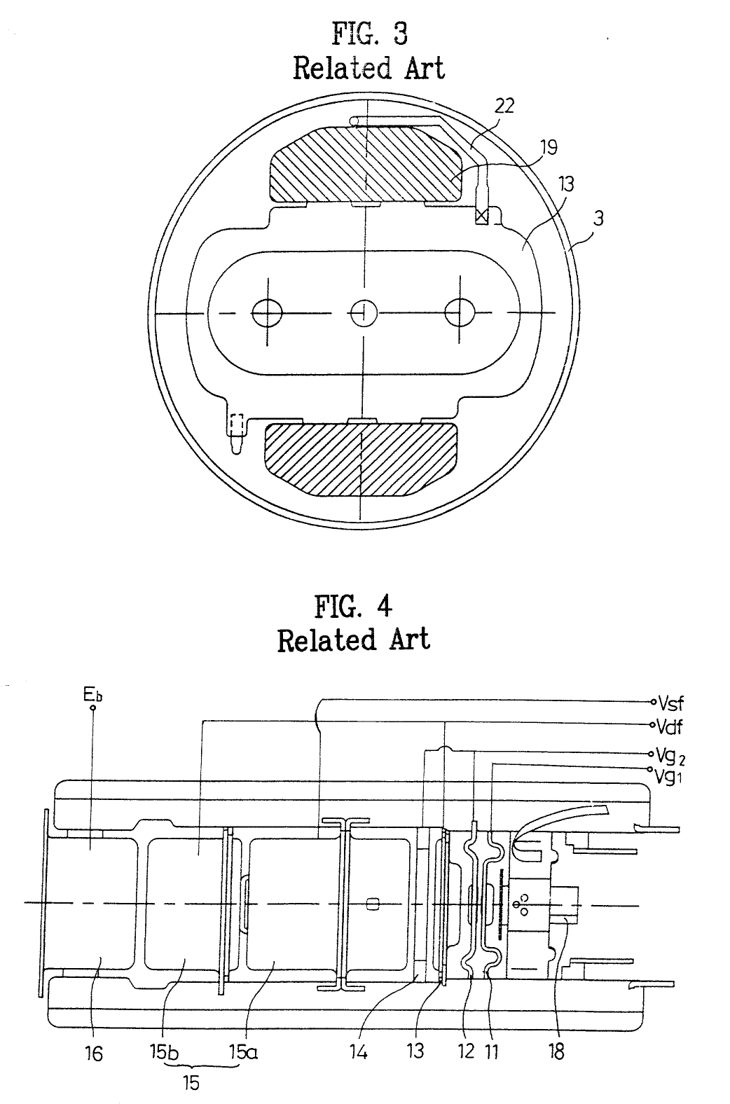

In order to focus the electron beams (see 4 in FIG. 1), or to form an exact electron beam spot on a periphery of the screen, the foregoing electrodes have various voltages applied thereto for forming the pre-focus lens, the main focus lens, and the quardrupole lens by means of their potential differences, wherein the third electrode 113 is connected as follows for having a voltage applied thereto. Since one end of the wire 122 is welded to the stem pin 121 the dynamic voltage applied thereto, and the other end of the wire 122 is welded to the third electrode 113, the third electrode has the dynamic voltage at the stem pin applied thereto (see FIG. 4). In order to prevent the inside wall of the neck part (see FIG. 3) form being scratched by the wire 122 during the electron gun sealing process (see 5 in FIG. 5), the wire has an evasive form so that the wire does not come into contact with the inside wall of the neck part. In order to prevent generation of noise occurred during the electron beams 4 move, the wire has an evasive form so as not to come into contact with the bead glass for preventing generation of contact noise by vibration between the wire and the bead glass.

In the meantime, referring to FIGS. 6 and 7, the second preferred embodiment of the present invention has the following elements. In the foregoing color CRT, there is a first wire 222a included thereto, which has one end welded to the dynamic electrode 215, the other end welded to the stem pin 221a having a dynamic voltage applied thereto, and a body between the one end and the other end having an evasive form so as not to come into contact with neighboring members, and a second wire 222b included thereto, which has one end welded to the third electrode 213, the other end welded to the stem pin 221b having a static voltage applied thereto, and a body between the one end and the other end having an evasive form so as not to come into contact with neighboring members.

The operation and work of the second preferred embodiment of the present invention will be explained.

In order to focus the electron beams 4, or to form an exact electron beam spot on a periphery of the screen, the foregoing electrodes have various voltages applied thereto for forming the pre-focus lens, the main focus lens, and the quardrupole lens by means of their potential differences, wherein the dynamic electrode 215 is connected as follows for having a voltage applied thereto. Since one end of the first wire 222a is welded to the stem pin 221a the dynamic voltage applied thereto, and the other end of the first wire 222a is welded to the dynamic electrode 215, the dynamic electrode has the dynamic voltage at the stem pin applied thereto (see FIG. 8), and since one end of the second wire 222b is welded to the stem pin 221b the static voltage applied thereto, and the other end of the second wire 222b is welded to the third electrode 213, the third electrode has the static voltage at the stem pin applied thereto (see FIG. 8). In order to prevent the inside wall of the neck part 3 form being scratched by the first wire 222a and the second wire 222b during the electron gun 5 sealing process, the first wire 222a and the second wire 222b has evasive forms so that the first wire 222a and the second wire 222b do not come into contact with the inside wall of the neck part. In order to prevent generation of noise occurred during the electron beams 4 move, the first wire 222a and the second wire 222b have evasive forms so as not to come into contact with the bead glass 219 for preventing generation of contact noise by vibration between the first wire 222a and the second wire 222b and the bead glass 219.

Referring to FIGS. 6 and 7, the evasive form of the wire applicable to the first or second embodiment is as follows.

The evasive form of the wire includes one portion located lower than, running parallel to, and not in contact with, the bead glass 219, and the other portion bent at an end of the bead glass and welded to the stem pin 221a or 221b.

Thus, since the wire has an evasive form so as not to come into contact with the inside wall of the neck, the inside wall of the neck is not liable to damage from scratch by the wire in an electron gun sealing process. Therefore, there is no liability of spark occurrence by a great potential difference at the inside wall of the neck, and defects coming from the spark can be reduced. The evasive form of the wire formed so as not to come into contact with the bead glass prevents occurrence of the contact vibration between the wire and the bead glass, that eliminates noise caused by the contact vibration.

It will be apparent to those skilled in the art that various modifications and variations can be made in the electron gun in a color CRT of the present invention without departing from the spirit or scope of the invention. Thus, it is intended that the present invention cover the modifications and variations of this invention provided they come within the scope of the appended claims and their equivalents.

What is claimed is:

1. An electron gun in a color cathode ray tube (CRT) comprising:
a plurality of stem pins for applying different voltages;
an acceleration electrode, a third electrode, a fourth electrode, and a static electrode, for forming pre-focus lenses;
a dynamic electrode and an anode for forming a main focus lens;
the static electrode and the dynamic electrode for forming a quardrupole lens;
bead glass for holding the foregoing electrodes at fixed distances; and,
a wire having one end welded to the third electrode, the other end welded to the stem pin a dynamic voltage applied thereto, and a body between the one end and the other end having an evasive form so as not to come into contact with neighboring members.

2. An electron gun in a color cathode ray tube (CRT) comprising:
a plurality of stem pins for applying different voltages;
an acceleration electrode, a third electrode, a fourth electrode, and a static electrode, for forming pre-focus lenses;
a dynamic electrode and an anode for forming a main focus lens;
the static electrode and the dynamic electrode for forming a quardrupole lens;
bead glass for holding the foregoing electrodes at fixed distances;
a first wire having one end welded to the dynamic electrode, the other end welded to the stem pin a dynamic voltage applied thereto, and a body between the one end and the other end having an evasive form so as not to come into contact with neighboring members; and,
a second wire having one end welded to the third electrode, the other end welded to the stem pin a static voltage applied thereto, and a body between the one end and the other end having an evasive form so as not to come into contact with neighboring members.

3. An electron gun as claimed in claims 1 or 2, wherein the evasive form includes;
one portion located lower than, running parallel to, and not in contact with, the bead glass, and
the other portion bent at an end of the bead glass, and welded to the stem pin.
